(19) United States
(12) Patent Application Publication
(10) Pub. No.: US 2011/0179255 A1
(43) Pub. Date: Jul. 21, 2011

(54) Data processing reset operations

(75) Inventors: Chiloda Ashan Senerath Pathirane, Haverhill (GB); Antony John Penton, Cambridge (GB); Andrew Christopher Rose, Cambridge (GB)

(73) Assignee: ARM Limited, Cambridge (GB)

(21) Appl. No.: 12/656,246

(22) Filed: Jan. 21, 2010

(51) Int. Cl. G06F 9/38; G06F 9/30; G06F 12/08

(52) U.S. Cl. 712/207; 712/239; 712/229; 711/125; 712/E09.045; 712/234; 712/E09.016; 711/E12.017

(57) ABSTRACT

A processor 4 is provided with reset circuitry 48 which generates a reset signal to reset a plurality of state parameters. Partial reset circuitry 50 is additionally provided to reset a proper subset of this plurality of state parameters. The reset circuitry triggers a redirection of program flow. The partial reset circuitry permits a continuation of program flow. The partial reset circuitry may be used to place processors into a known state with a low latency before switching from a split mode of operation into a locked mode of operation.

### BACKGROUND OF THE INVENTION

1. Field of the Invention

This invention relates to the field of data processing systems. More particularly, this invention relates to the provision of reset signals within data processing systems.

2. Description of the Prior Art

It is known to provide data processing systems with reset signals which, when asserted, trigger the data processing system to perform a reset operation. Reset operations typically reinitialise the data processing system and place it into a known state/configuration. When first powered on, a data processing system normally starts from this reset configuration and then initialises itself to the point where it is ready to start useful processing (i.e. a power-on reset). A reset signal may also be asserted during ongoing use, such as on occurrence of an error signal indicating that the system has departed from proper operation when the use of the reset signal can return the system to a known state. It is also known to provide systems with functional circuitry (for executing a stream of program instructions) and diagnostic circuitry for performing debug/diagnostic operations on the functional circuitry. The functional circuitry and the diagnostic circuitry may have separate reset signals.

The initialisation or reinitialisation performed as part of a reset operation is typically extensive and can take many hundreds or thousands of processing cycles. Various state parameters within the data processing system need to be set to known values in order to place the system into a determined overall state from which normal processing can start. Examples of the state parameters which may require resetting are valid flags within a cache memory and memory management unit (or memory protection unit). Upon occurrence of a reset, a cache memory, a memory management unit (or a memory protection unit) may contain data values but these may be erroneous, or at least vary, and so cause the system not to be in a known state. Accordingly, the reset processing must go through the cache memory, memory management unit or (memory protection unit) writing all the valid flags to indicate that the data is invalid. A consequence of this processing typically required upon occurrence of a reset is that the latency associated with the time between the reset signal being asserted and the time at which the system is ready to continue processing is large.

A further use of reset is to place the system into a known configuration such that predictable processing can thereafter be performed. As an example, a data processing system may include a branch prediction mechanism. The current state of the branch prediction mechanism can have a significant impact upon how quickly a given sequence of program instructions will execute. If the branch prediction mechanism contains correct predictions, then the sequence may execute rapidly. Conversely, if the branch prediction mechanism does not contain data allowing it to make correct predictions, then execution of the same sequence of processing instructions may take considerably longer. This can be a significant problem when seeking to benchmark the behaviour of a data processing system, investigate bugs within a data processing system or provide highly consistent behaviour, such as in safety critical systems.

### SUMMARY OF THE INVENTION

Viewed from one aspect the present invention provides apparatus for processing data comprising:

a processor responsive to a stream of program instructions to execute processing operations in a sequence corresponding to a program flow, said processor having a plurality of state parameters of non-diagnostic circuitry within said processor;

a reset circuit responsive to a reset signal to trigger a reset operation, said reset operation resetting said plurality of state parameters of said processor and forcing a change of said program flow; and

at least one partial reset circuit responsive to a partial reset signal to trigger a partial reset operation, said partial reset operation resetting a proper subset of said plurality of state parameters of said processor and permitting a continuation of said program flow.

The present technique recognises that while a standard reset operation is useful in data processing systems, it has an associated disadvantageously long latency associated with its operation and is illsuited to use in many situations in which it is desired to place the system into a known state before continuing processing. Thus, in addition to the normal reset operation which resets a plurality of state parameters (but not necessarily every state parameter of the processor) and forces a change of program flow, e.g. triggers processing to follow a reset vector, the present technique additionally provides for at least one additional partial reset signal which triggers a partial reset operation that resets a proper subset of the plurality of data parameters (relating to non-diagnostic circuitry within the processor, e.g. not state parameters of a breakpoint/watchpoint unit or a tracing unit) that are reset by the full reset signal and which permits a continuation of the program flow, i.e. does not alter the program flow from that which would otherwise take place (the same sequence of program instructions will be executed although the timing may alter). It will be appreciated that some diagnostic circuitry can alter the non-diagnostic state and such embodiments are encompassed.

The partial reset signal may be generated in a number of ways. As examples, the partial reset signal may be generated as an external signal and/or under hardware control. The partial reset signal may also be generated in response to a program instruction executed by the apparatus, e.g. a partial reset instruction may be added to the instruction set which triggers generation of the partial reset signal, or the partial reset signal may be generated in response to a received diagnostic control signal, e.g. a debug signal or pattern of debug signals may trigger the debug system to generate a partial reset.

While the proper subset of the plurality of state parameters which are reset by the partial reset operation may vary and be distributed throughout the apparatus, it is more usual within an apparatus comprising a plurality of functional circuit blocks to arrange the proper subset such that it serves to reset one or more of the plurality of functional circuit blocks, while other of the functional circuit blocks are not reset and continue to hold their state values. These other functional circuit blocks which are not reset by the partial reset operation may instead, if required, be reset by software instructions if they are accessible using the programming model of the apparatus.

The technique of providing partial reset operations is particularly useful in the context of an apparatus containing a plurality of processors and in which the pluralities of processors may operate in either a locked mode or a split mode. In the locked mode of operation each of the processors separately and during a corresponding processing cycle executes a common processing operation to generate respective processing results such that these processing results may be compared by comparison circuitry to identify incorrect operation. This is useful in providing a high resistance to errors. In the split mode of operation, each of the plurality of processors may separately and during the same processing cycle execute a different processing operation to generate respective different processing results, i.e. each processor may follow its own program flow.

Within the context of such systems synchronisation circuitry may be provided to generate a partial reset signal for each of the processors upon switching from the split modes to the locked mode such that a proper subset of the plurality of state parameters is reset to common values before processing operations in the locked mode commence. Thus, each of the processors may be placed into the same state before locked mode operation commences while not incurring the large latency overhead associated with a full reset. The partial reset operation may reset only those state parameters necessary to achieve proper locked operation, or at least those which are not otherwise accessible to software and so capable of being placed into a known state by execution of an appropriate normalising sequence of program instructions.

The switching between the split mode and the locked mode may take place via a quiescent mode in which execution of processing operations is halted awaiting receipt of a wake-up signal. Thus, each of the processors may be normalised (i.e. through use of the partial reset signal and/or any normalising software) and then placed into the quiescent mode waiting for the remainder of the processors to also be ready to start the locked mode of operation. Thus, when the synchronisation circuitry detects that each of the processors is within the quiescent mode then they may be subject to a wake-up signal asserted to trigger the plurality of processors to together enter the locked mode of operation.

It is possible for the system to contain multiple clock domains and multiple power domains with the different functional blocks split between these in differing ways. In some embodiments the processor which is subject to the normal full reset signal and the partial reset signal may be within a single clock domain.

The plurality of state parameters which are subject to reset, at least within the proper subset of the plurality of state parameters, are micro-architectural parameters that are not part of a programming model of the processor. Thus, these micro-architectural parameters are not able to be placed into a known condition by the execution of software in a convenient manner.

It will be appreciated that the effect of the partial reset can vary and in particular which functional units are subject to the partial reset can vary between different implementations of the present technique. Examples of functional blocks which are not reset by the partial reset include a register bank, a cache memory, and a memory control unit (such as a memory management unit or a memory protection unit).

In a similar way, the functional units which are reset by the partial reset operation can vary. Examples of functional units which are reset by the partial reset operation include branch prediction circuitry, a processing pipeline (i.e. pipeline state such as interlocks, forwarding paths etc), a hard-error cache memory, a prefetch unit and/or a call return stack.

Viewed from another aspect the present invention provides apparatus for processing data comprising:

processor means responsive to a stream of program instructions for executing processing operations in a sequence corresponding to a program flow, said processor means having a plurality of state parameters of non-diagnostic circuitry within said processor;

reset means responsive to a reset signal for triggering a reset operation, said reset operation resetting said plurality of state parameters of said processor and forcing a change of said program flow; and

at least one partial reset means responsive to a partial reset signal for triggering a partial reset operation, said partial reset operation resetting a proper subset of said plurality of state parameters of said processor and permitting a continuation of said program flow.

Viewed from a further aspect the present invention provides a method of processing data, said method comprising the steps of:

in response to a stream of program instructions, executing with a processor processing operations in a sequence corresponding to a program flow, said processor having a plurality of state parameters of non-diagnostic circuitry within said processor;

in response to a reset signal, triggering a reset operation, said reset operation resetting said plurality of state parameters of said processor and forcing a change of said program flow; and

in response to a partial reset signal, triggering a partial reset operation, said partial reset operation resetting a proper subset of said plurality of state parameters of said processor and permitting a continuation of said program flow.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a system-on-chip integrated circuit include multiple processors responsive to both a reset signal and a partial reset signal;

FIG. 2 schematically illustrates one of the processors of FIG. 1;

FIG. 3 is a flow diagram schematically illustrating the operation of a processor switching from a split mode via a quiescent mode to a locked mode; and

FIG. 4 is a flow diagram schematically illustrating operation of synchronisation circuitry for controlling multiple processors to switch from a split mode via a quiescent mode to a locked mode.

### DESCRIPTION OF THE EMBODIMENTS

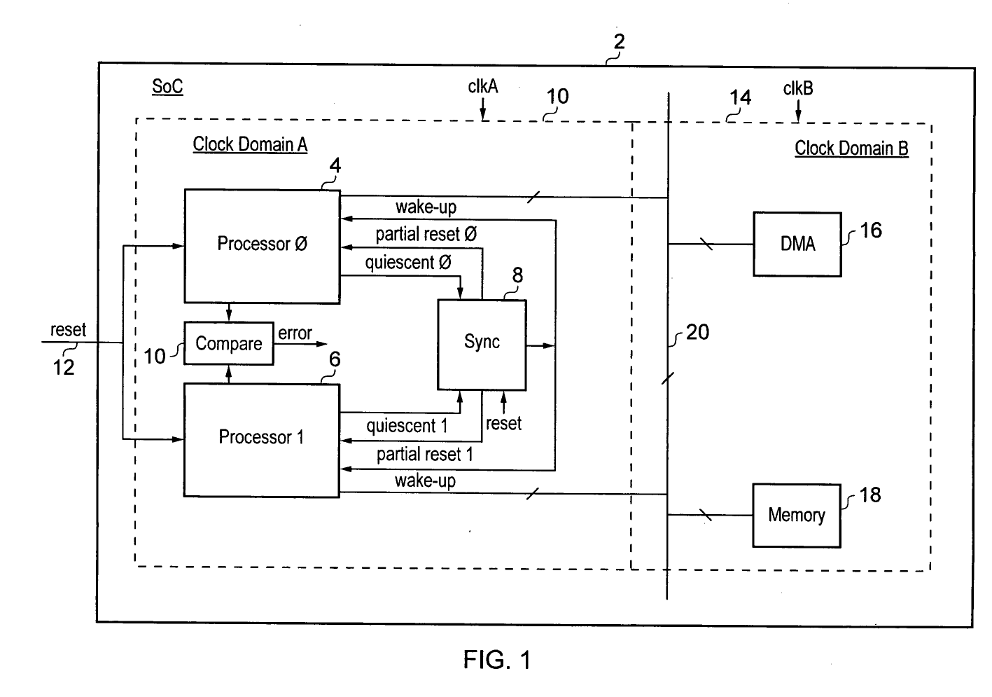

FIG. 1 illustrates a system-on-chip integrated circuit 2 including a first processor 4 and a second processor 6. Synchronisation circuitry 8 serves to control switching of the first processor 4 and the second processor 6 between a split mode of operation in which each operates independently and a locked mode of operation in which each processor executes the same program flow on the same data (possibly with a timing offset therebetween) and comparison circuitry 10 serves to compare the processing results and generate an error signal if these differ, e.g. following a hard error, a soft error or some other event.

The first processor 4 and the second processor 6 are within the same clock domain 10 and are subject to a reset signal received from outside of the integrated circuit 2 which serves to fully reset both the first processor 4 and the second processor 6. This reset signal received on reset signal line 12 places state parameters of the first processor 4 and the second processor 6 into known values and redirects program flow to a predetermined reset vector such that a reset processing routine can commence execution. This reset processing routine will typically initialise many other aspects of the first processor 4 and the second processor 6 before these are ready to be released for ongoing processing, e.g. cache memories may be invalidated, state accessible via the programming model set up or at least invalidated etc.

Also illustrated in FIG. 1 is a further clock domain 14 which includes further functional units such as a direct memory access unit 16 and a main memory 18. The direct memory access unit 16 and the main memory 18 are connected to the first processor 4 and the second processor 6 via a bus 20.

The synchronisation circuitry 8 serves to control generation and use of a partial reset signal that is applied to each of the first processor 4 and the second processor 6. The synchronisation circuitry 8 may be responsive to an externally received signal or execution of a predetermined program instruction to initiate a move between a split mode of operation and a locked mode of operation. Before the lock mode of operation can be entered the first processor 4 and the second processor 6 are placed into the same configuration, including state parameters which are not accessible in the programming model. The partial reset signal is applied to each of the first processor 4 and the second processor 6 and serves to set these state parameters, which are not accessible via the programming model and which are a proper subset of the full state of parameters which are reset by the reset signal on reset signal line 12, into a predetermined state. The synchronisation circuitry 8 is itself reset by the reset signal r on reset signal line 12 but is not reset by the partial reset signal pr as the synchronisation circuitry 8 generates this signal and controls the switching of the processors 4, 6 into the locked mode via quiescent states and a wake-up event. The wake-up role of the synchronisation circuitry 8 means it must remain active through the partial reset of other circuit elements.

The sequence of operations upon moving between the split mode of operation and the locked mode of operation is that each of the first processor 4 and the second processor 6 executes a sequence of normalising program instructions which place parameter values accessible in the programming model to a known state and then triggers entry into a quiescent mode of operation in which the processor stops executing instructions and waits for a wake-up signal to be received. When the wake-up signal is received, the processing recommences and there is no redirection of program flow, e.g. the program counter value is not changed and both of the first processor 4 and the second processor 6 start executing from the same point where they were respectively “parked” upon entry into the quiescent mode.

The synchronisation circuitry 8 is responsive to signals from each of the first processor 4 and the second processor 6 indicating that they have entered the quiescent mode. When both the first processor 4 and the second processor 6 are in the quiescent mode, then the synchronisation circuitry 8 generates a partial reset signal directed to the first processor 4 and the second processor 6 which serves to reset a proper subset of the plurality of state parameters which are reset by a full reset into known states. After the partial reset operation has completed, then the synchronisation circuitry 8 generates a wake-up signal which triggers each of the first processor 4 and the second processor 6 to start execution in the locked mode of operation, although they may have one or more clock cycles offset in their operations they will in corresponding processing cycles execute the same processing operations on the same data values to generate the same results if there are no errors within the system.

It will be appreciated that in this example embodiment the partial reset signals and the wake-up signals have been separately illustrated. It will be possible for these to be combined into a single signal to which the respective first processor 4 and the second processor 6 respond by initiating the partial reset operation followed by commencing processing in the locked mode of operation.

It will be further appreciated that while the example illustrated in FIG. 1 illustrates two processors 4, 6, it is possible to use the present techniques within systems including more than two processors. It is also possible to use the present techniques in respect of only a single processor, as a partial reset signal may be desirable to place this single processor into a known state with low latency. For example, when seeking to achieve predictable behaviour, a partial reset can be used to place the state parameters which are not accessible via the programming model (e.g. branch predictor state) into a known configuration such that a sequence of program instructions will execute in a deterministic fashion, e.g the speed of execution will not be influenced by the particular state of the branch prediction mechanisms. This deterministic behaviour can be achieved using the partial reset signal without the large latency overhead and other effects associated with a full reset operation.

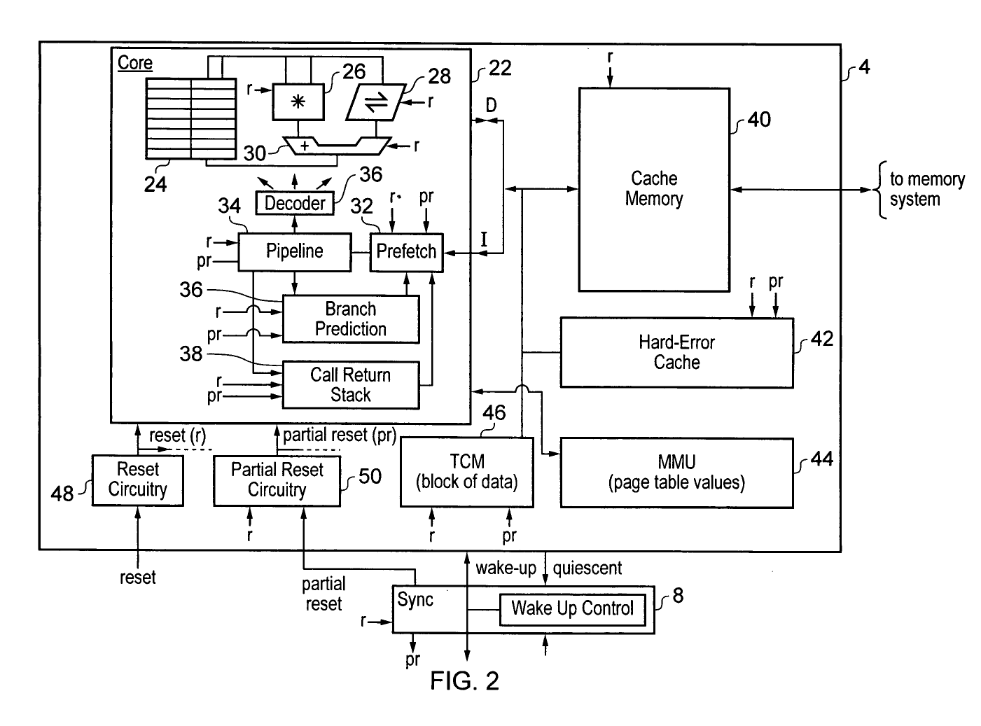

FIG. 2 illustrates a processor 4 in more detail. The processor 4 includes a processing core 22 including a register bank 24, a multiplier 26, a shifter 28 and an adder 30, which together form the main data path within the processor core 22. Other datapath circuits could also be present, e.g. a hardware divider. It is also possible that fewer datapath circuits may be provided. Program instructions to be executed are prefetched by a prefetch unit 32 and supplied to a processing pipeline 34 where they control an instruction decoder 36 to generate control signals which configure and control operation of the data path 24, 26, 28, 30. Branch prediction circuitry 36 serves to generate predicted branch outcomes to influence the sequence of program instructions supplied to the pipeline 34. A call return stack 38 seeks to predict call return outcomes which again influence the sequence of instructions supplied to the pipeline 34. It will be appreciated that the processing core 22 may contain many further functional blocks and that only a small section of the functional blocks within the processing core 22 have been illustrated. Furthermore, it will be appreciated that not all of these functional blocks need be provided.

Also, provided within the processor 4 are a cache memory 40, a hard error cache 42 and a memory management unit 44 together with a tightly coupled memory 46. The cache memory 40 stores data and instruction values which are supplied to the processing core 22. The hard error cache 42 stores corrected values which have had hard errors identified in them within the values stored within the off-processor memory system, such that the corrected versions of these data values or instructions are supplied directly from the hard error cache 42 when they are reused rather than being refetched in erroneous form from the memory system and subject to error correction. The memory management unit 44 stores page table values for controlling access to the memory, such as mappings between virtual and physical memory, protection attributes and the like. The tightly coupled memory 46 stores a block of data values, such as providing a scratch pad memory for high speed local use by the processing core 22.

Within the processor 4 there is provided reset circuitry 48 and partial reset circuitry 50. The reset circuitry 48 is responsive to a reset signal to reset the full plurality of state parameters which are subject to reset within the processor 4. The reset circuitry 48 is not reset by the partial reset signal pr. This reset signal r is shown as an input to each of the functional units within the processor 4 which is subject to this full reset. In a similar way, the partial reset circuitry 50 is responsive to a received partial reset signal to forward a partial reset pr to those functional units which are subject to this partial reset of operations. It will be seen that the functional units which are subject to the partial reset are a proper subset of the functional units in the whole of the processor 4 and accordingly the state parameters which are subject to partial reset are a proper subset of the state parameters which are subject to the full reset operation. In this example embodiment the register bank 24, the cache memory 40 and the memory management unit are subject to neither the full reset or the partial reset and are instead initialised under software control by execution of normalising program instructions prior to entry into the quiescent mode. The multiplier 26, the shifter 28 and the adder 30 are subject to a full reset under control of the reset signal r, but are not reset by the partial reset signal pr. In some embodiments the multiplier 26, the shifter 28 and the adder 30 may be reset under control of both the reset signal r and the partial reset signal pr to assist normalization when entering a lock-step mode of execution of processors 4 and 6.

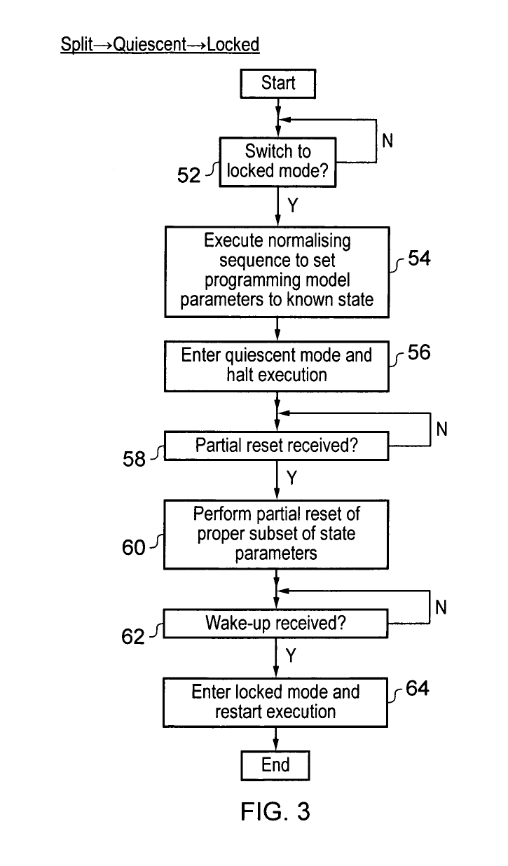

FIG. 3 is a flow diagram schematically illustrating the operation of the processor 4 when switching from the split mode via the quiescent mode to the locked mode. At step 52 the processor 4 waits until a switch to the locked mode starts to be initiated. This will typically be under software control. Step 54 executes a normalising sequence of program instructions to set parameters accessible via the programming model to a known state. At step 56 the processor 4 then enters the quiescent mode. The processor 4 waits at step 58 until the partial reset signal is received from the synchronising circuitry 8. When the partial reset signal is received, step 60 performs a partial reset of a proper subset of the state parameters of the processor 4 as illustrated in FIG. 2. The processor 4 then waits at step 62 for the wake-up signal to be received from the synchronising circuitry 8. When the wake-up signal is received, step 64 enters the locked mode of operation and restarts execution of program instructions by the processor 4. This restarting of program instructions is without a redirection of program flow occurring. Thus, a partial reset will be seen to take place without a redirection of program flow, whereas a full reset forces a change of program flow back to a known sequence of program instructions, such as the reset initialisation routine.

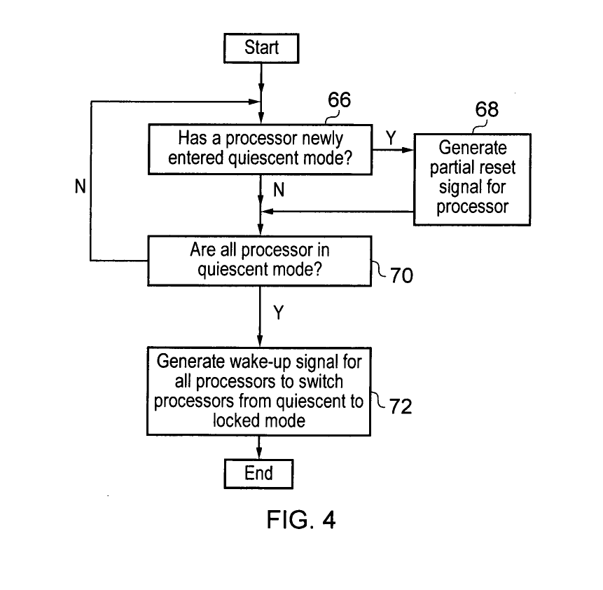

FIG. 4 is a flow diagram schematically illustrating the operation of the synchronisation circuitry 8. At step 66 the synchronisation circuitry 8 waits to receive a signal from one of the first processor 4 and the second processor 6 indicating that the processor has newly entered the quiescent mode. When the processor 4 or the processor 6 has entered the quiescent mode, then step 68 generates a partial reset signal for that processor.

Step 70 determines whether all of the processors are now in the quiescent mode. If any of the processors are not yet in the quiescent mode, then processing returns to step 66. If all of the processors are in the quiescent mode, then processing proceeds to step 72 where the synchronisation circuitry 8 generates a wake-up signal for all of the processors to switch the processors from the quiescent mode to the locked mode at which they start executing program instructions in a lock-step fashion.

In the above described embodiment the partial reset signal has been used to assist the switch into a locked mode of operation of a system-on-chip containing multiple processors. The partial reset signal may also be used in other circumstances. For example, the partial reset signal could be useful in benchmarking or security applications. In a system containing branch history circuitry and/or branch prediction circuitry, then a partial reset signal may be used to reset this circuitry into a predetermined state before running a benchmark. In this way, more reliable comparisons may be made between different occasions upon which the benchmark is nm. If the branch history or branch prediction circuitry is not in a known state when a benchmark is run, then the variable state of this circuitry may have a considerable impact upon the speed and manner of operation of the system during the benchmarking. This normalizing before benchmarking can also apply to other circuit elements/state such as data history buffers, translation lookaside buffers etc. Furthermore, the branch history and branch prediction mechanisms may contain sensitive information regarding the past behavior of a system which it may be desirable to remove when executing a secure state. Thus, when switching between a secure mode of operation and non-secure mode of operation it may be desirable to issue a partial reset signal to the branch history and/or branch prediction mechanisms within a system in order that no information regarding the past behavior of the system in the secure mode may leak into the non-secure mode via these mechanisms. The partial reset can also be applied to all secure/sensitive state. The present techniques thus provide apparatus and methods for improved benchmarking as well as improved systems which offer both secure modes of operation and non-secure modes of operation (e.g. the TrustZone enabled processors designed by ARM Limited of Cambridge, England).

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. Apparatus for processing data comprising:
a processor responsive to a stream of program instructions to execute processing operations in a sequence corresponding to a program flow, said processor having a plurality of state parameters of non-diagnostic circuitry within said processor;
a reset circuit responsive to a reset signal to trigger a reset operation, said reset operation resetting said plurality of state parameters of said processor and forcing a change of said program flow; and
at least one partial reset circuit responsive to a partial reset signal to trigger a partial reset operation, said partial reset operation resetting a proper subset of said plurality of state parameters of said processor and permitting a continuation of said program flow.

2. Apparatus as claimed in claim 1, wherein said partial reset signal is one of:
(i) generated under hardware control;
(ii) generated in response to a program instruction; and
(iii) generated in response to a received diagnostic control signal.

3. Apparatus as claimed in claim 1, wherein said processor comprises a plurality of functional circuit blocks configured to perform different operations and said proper subset of said plurality of state parameters serve to reset one or more of said plurality of functional circuit blocks.

4. Apparatus as claimed in claim 1, comprising comparison circuitry and wherein said processor is one of a plurality of processors within said apparatus, said plurality of processors having:
(i) a locked mode of operation in which each of said plurality of processors separately and during a corresponding processing cycle executes a common processing operation to generate respective processing results, said processing results of different processors being compared by said comparison circuitry to identify incorrect operation; and
(ii) a split mode of operation in which each of said plurality of processors separately and during said same processing cycle executes a different processing operation to generate respective different processing results.

5. Apparatus as claimed in claim 4, comprising a synchronisation circuitry configured to generate a partial reset signal for each of said plurality of processors upon switching from said split mode to said locked mode such that said proper subset of said plurality of state parameters are reset to common values before execution of processing operations in said locked mode commences.

6. Apparatus as claimed in claim 5, wherein said switching between said split mode and said locked mode takes place via a quiescent mode in which execution of processing operations is halted awaiting receipt of a wake-up signal.

7. Apparatus as claimed in claim 6, wherein said synchronisation circuitry generates said wake-up signal to trigger said plurality of processors to switch from said quiescent mode to said locked mode after each of said plurality of processors has being subject to a respective partial reset operation.

8. Apparatus as claimed in claim 4, wherein before switching from said split mode to said locked mode each of said plurality of processors executes a normalising sequence of program instructions to set a plurality of state parameters that are part of a programming model of each of said plurality of processors to a common value.

9. Apparatus as claimed in claim 1, wherein said processor is within a single clock domain.

10. Apparatus as claimed in claim 1, wherein said plurality of state parameters are micro-architectural parameters that are not part of a programming model of said processor.

11. Apparatus as claimed in claim 1, wherein said processor comprises a register bank of registers configured to store data values to be subject to said processing operations and said partial reset does not reset said register bank.

12. Apparatus as claimed in claim 1, wherein said processor comprises a cache memory configured to store data values to be subject to said processing operations and said partial reset does not reset said cache memory.

13. Apparatus as claimed in claim 1, wherein said processor comprises a memory control unit configured to use page table values to control memory accesses as part of said processing operations and said partial reset does not reset said memory control unit.

14. Apparatus as claimed in claim 1, wherein said processor comprises branch prediction circuitry configured to predict branch behaviour within said program flow and said proper subset comprises state parameters of said branch prediction circuitry such that said partial reset operation resets said branch prediction mechanism.

15. Apparatus as claimed in claim 1, wherein said processor comprises processing pipeline configured to perform pipelined execution of said program instructions and said proper subset comprises state parameters of said processing pipeline such that said partial reset operation resets said processing pipeline.

16. Apparatus as claimed in claim 1, wherein said processor comprises a hard-error cache memory configured to store corrected data values corresponding to data values stored elsewhere within said apparatus and subject to a hard-error and said proper subset comprises corrected data values such that said partial reset operation resets said hard-error cache memory.

17. Apparatus as claimed in claim 1, wherein said processor comprises a prefetch unit configured to prefetch program instructions to be executed and said proper subset comprises state parameters of said prefetch unit such that said partial reset operation resets said prefetch unit.

18. Apparatus as claimed in claim 1, wherein said processor comprises a call return stack memory configured to store return addresses of call instructions and said proper subset comprises said return addresses stored in said call return stack memory such that said partial reset operation resets said call return stack memory.

19. Apparatus for processing data comprising:
processor means responsive to a stream of program instructions for executing processing operations in a sequence corresponding to a program flow, said processor means having a plurality of state parameters of non-diagnostic circuitry within said processor;
reset means responsive to a reset signal for triggering a reset operation, said reset operation resetting said plurality of state parameters of said processor and forcing a change of said program flow; and
at least one partial reset means responsive to a partial reset signal for triggering a partial reset operation, said partial reset operation resetting a proper subset of said plurality of state parameters of said processor and permitting a continuation of said program flow.

20. A method of processing data, said method comprising the steps of:
in response to a stream of program instructions, executing with a processor processing operations in a sequence corresponding to a program flow, said processor having a plurality of state parameters of non-diagnostic circuitry within said processor;
in response to a reset signal, triggering a reset operation, said reset operation resetting said plurality of state parameters of said processor and forcing a change of said program flow; and
in response to a partial reset signal, triggering a partial reset operation, said partial reset operation resetting a proper subset of said plurality of state parameters of said processor and permitting a continuation of said program flow.
